(19) United States
(12) Patent Application Publication
(10) Pub. No.: US 2006/0240986 A1
(43) Pub. Date: Oct. 26, 2006

(54) Herbicidal method

(75) Inventors: Yoshinao Sada, Osaka (JP); Satoru Kizawa, Kakogawa-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 11/408,200

(22) Filed: Apr. 21, 2006

(30) Foreign Application Priority Data
Apr. 26, 2005 (JP) 2005-127591

(51) Int. Cl. A01N 43/40

(52) U.S. Cl. 504/130

(57) ABSTRACT

A combination of N-(7-fluoro-3,4-dihydro-3-oxo-4-prop-2-ynyl-2H-1,4-benzoxadin-6-yl)cyclohex-1-ene-1,2-dicarboxamide [Flumioxazin] and 1-(2-chloroimidazo[1,2-a]pyridin-3-ylsulfonyl)-3-(4,6-dimethoxypyrimidin-2-yl)urea [Imazosulfuron], wherein the weight ratio of Flumioxazin:Imazosulfuron is 1:0.1-20, is useful for controlling weeds in peanut field, vegetable field, tree field or non-cultivated land.

### TECHNICAL FIELD

This invention directs to herbicidal method.

### BACKGROUND ART

N-(7-fluoro-3,4-dihydro-3-oxo-4-prop-2-ynyl-2H-1,4-benzoxadin-6-yl)cyclohex-1-ene-1,2-dicarboxamide [Flumioxazin] is a herbicidal compound described in U.S. Pat. No. 4,640,707. And, 1-(2-chloroimidazo[1,2-a]pyridin-3-ylsulfonyl)-3-(4,6-dimethoxypyrimidin-2-yl)urea [Imazosulfuron] is also a herbicidal compound described in U.S. Pat. No. 5,017,212. Further, it is suggested that the combination of Flumioxazin and Imazosulfuron may be used for controlling weeds in rice field in WO 00/27203.

### DISCLOSURE OF THE INVENTION

This invention is to provide a method for controlling many species of weeds by excellent herbicidal effect without phytotoxicity to crops. In detail, the invention provides a method for controlling weeds in peanut field, vegetable field and tree field. Further, the invention also provides a method for controlling weeds in non-cultivated land.

According to the present invention, a combination of Flumioxazin and Imazosulfuron, wherein the weight ratio of Flumioxazin:Imazosulfuron is 1:0.1-20, is useful for controlling weeds in peanut field, vegetable field, tree field and non-cultivated land. Each of Flumioxazin and Imazosuifuron can be applied separately to weeds or to soil in a place where the weeds grow or will grow. In that case, a formulation of Flumioxazin and a formulation of Imazosulfuron are applied simultaneously or sequentially in general. However, Flumioxazin and Imazosulfuron are usually mixed and formulated in advance to a herbicidal composition comprising both of Flumioxazin and Imazosulfuron as active ingredients, which is applied to weeds or to soil in a place where the weeds grow or will grow.

The composition comprising Flumioxazin and Imazosulfuron is used for controlling many species of weeds effectively in the fields where crops are cultivated with or without tillage such as peanut field, vegetable field and tree field. In those cases, it does not cause significant phytotoxicity to useful plants. Further, it also can be used for controlling weeds in non-cultivated land.

In the composition, the mixing ratio of Flumioxazin:Imazosulfuron used as active ingredients is about 1:0.1-20, preferably about 1:0.2-10.

The composition is usually used for being formulated to emulisiable concentrates, wettable powders, suspensible concentrates, granules and so on by mixing a solid carrier or liquid carrier and optionally surfactant and the other auxiliary for formulation. These formulations generally contain about 0.1 to 90% by weight, preferably about 1 to 80% by weight of the total amount of Flumioxazin and Imazosulfuron.

Examples of the solid carrier used for formulating the composition include fine powders and granules of clays such as kaolinite, diatomaceous earth, Fubasami clay, bentonite and terra alba; synthetic hydrated silica; talc; sericite; quartz; and the other inorganic minerals such as sulfur, activated carbon and calcium carbonate; and chemical fertilizer such as ammonium sulfate, ammonium phosphate, ammonium nitrate, ammonium chloride and urea. Examples of the liquid carrier include water; alcohols such as methanol and ethanol; ketones such as acetone, ethyl methyl ketone and cyclohexanone; aromatic hydrocarbons such as toluene, xyiene, ethyibenzene and methylnaphthalene; non-aromatic hydrocarbons such as hexane, cyclohexane and kerosene; esters such as ethyl acetate and butyl acetate; nitriles such as acetonitrile and isobutyronitrile; ethers such as dioxane and diisopropyl ether; acid amides such as dimethylformamide and dimethylacetamide; and halogenated hydrocarbons such as dichloroethane and trichloroethylene.

Examples of the surfactant used for formulating the composition include alkyl sulfate esters, alkylsulfonate salts, alkylarylsulfonate salts, alkylaryl ethers, polyoxyethylene alkylaryl ethers, polyethylene glycol ethers, polyvalent alcohol esters and sugar alcohols. Examples of the other auxiliary for formulation include sticking agents and dispersants such as casein; gelatin; polysaccharide (e.g., starch, gum arabic, cellulose derivatives, alginic acid); lignin derivatives; bentonite; and synthetic water-soluble polymers (e.g., polyvinyl alcohol, polyvinylpyrrolidone, polyacrilic acid); and stabilizers such as PAP (isopropyl acid phosphate), BHT (2,6-tert-butyl-4-methylphenol), BHA (2-/3-tert-butyl-4-methoxyphenol), vegetable oil, mineral oil, fatty acid and fatty acid ester.

The composition can also be prepared by mixing each formulation after formulating each of the active ingredients with the above-mentioned procedure.

The composition obtained above can be applied as it is. Further, it can be diluted with water or the like, and then the dilution can be applied to soil or a plant. It may be expected to increase the herbicidal effect by using the composition together with another herbicide. Moreover, the composition can be used with an insecticide, fungicide, plant growth regulator, fertilizer, safener, soil-improving agent and so on.

The dosage of the composition depends on the mixing ratio of Flumioxazin and Imazosulfuron as active ingredients, weather condition, formulation type, application time, application method, application place, objective weeds and crops. The total amount of the active ingredients is usually about 1 to 1000 g per hectare. When the formulation is emulisiable concentrate, wettable powder, suspensible concentrate, the designated amount is usually diluted with about 100 to 2000 liters of water per hectare and applied. Further, when the composition is applied to weeds by foliar treatment, it is expected to increase herbicidal effect against weeds by adding an adjuvant to the dilution of the composition.

In the vegetable field of the present invention, examples of the crop include Solanaceae crops such as eggplant, tomato, green pepper and potato; Cucurbitaceae crops such as cucumber, squash, zucchini, watermelon and melon; Crusiferae crops such as radish, turnip, horseradish, Kohlrabi, Chinese cabbage, cabbage, mustard, broccoli and cauliflower; Rosaceae crops such as strawberry; Compositae crops such as burdock, crown daisy, artichoke and lettuce; Liliaceae crops such as leek, onion, garlic and asparagus; Umbelliferae crops such as carrot, parsley, celery and parsnip; Chenopodiaceae crops such as spinach and Swiss chard; Labiatae crops such as perilla, mint, basil and lavender; Convolvulaceae crops such as sweet potato; Dioscoreaceae crops such as yam; Araceae crops such as taro; and Euphorbiaceae crops such as cassava.

The tree field of the present invention can be orchard and non-bearing tree field. Examples of the orchard include pome fruits such as apple, pear (e.g. pear, Japanese pear), quince (e.g. quince, Chinese quince); stone fruits such as peach, plum (e.g. plum, Japanese plum), nectarine, apricot (e.g. apricot, Japanese apricot) and cherry; grapes; citrus such as orange (e.g. orange, Satsuma orange), lemon, lime and grapefruit; tree nuts such as chestnut, walnut, hazel, almond, pistachio, cashew and macadamia; berries such as blueberry, cranberry, blackberry and raspberry; persimmon (e.g. persimmon, Japanese persimmon); fig; loquat; olive; palm; banana; coffee; tea; and mulberry. Examples of the non-bearing tree include Deciduous trees such as ash (Fraxinus spp.), birch (Betula spp.), dogweed (Cornus spp.), poplar (Poplus spp.), redbud (Cercis spp.), sycamore (Platanus spp.) and zelkova (Zelkova spp.) and Conifer such as arborvitae (Thuja spp.), fir (Abies spp.), hemlock (Tsuga spp.), juniper (Juniperus spp.), pine (Pinus spp.), spruce (Picea spp.) and yew (Taxus spp.). The tree field of the present invention can be tree nursery, tree farm, forest and so on.

Examples of the non-cultivated land in the present invention include playground, vacant land, neighborhood of railroad, park, car park, neighborhood of road, dry riverbed, land under power-transmission line, land for housing and site for factory.

Examples of the weeds include:
Polygonaceae weeds such as Polygonum convolvulus (wild buckwheat), Polygonum lapathifolium (pale smartweed), Polygonum pensylvanicum (Pennsylvania smartweed), Polygonum persicaria (ladysthumb), Rumex crispus (curly dock), Rumex obtusifolius (European dock) and Polygonum cuspidatum (Japanese knotweed);
Portulacaceae weeds such as Portulaca oleracea (common purslane);
Caryophyllaceae weeds such as Stellaria media (common chickweed);
Chenopodiaceae weeds such as Chenopodium album (common lambsquarters) and Kochia scoparia (fireweed);
Amaranthaceae weeds such as Amaranthus retroflexus (redroot pigweed) and Amaranthus hybridus (smooth pigweed);
Crusiferae weeds such as Raphanus raphanistrum (wild radish), Sinapis arvensis (wild mustard) and Capsella bursa-pastoris (shepherdspurse);
Leguminosae weeds such as Sesbania exaltata (hemp sesbania), Cassia obtusifolia (sicklepod), Desmodium tortuosum (Florida beggarweed) and Trifolium repens (white clover);
Malvaceae weeds such as Abutilon theophrasti (velvetleaf) and Sida spinosa (prickly sida);
Violaceae weeds such as Viola arvensis (field pansy) and Viola tricolor (wild pansy);
Rubiaceae weeds such as Galium aparine (cleavers);
Convolvulaceae weeds such as Ipomoea hederacea (ivyleaf morningglory), Ipomoea purpurea (tall morningglory), Ipomoea hederacea var integriuscula (entireleaf morningglory), Ipomoea lacunose (pitted morningglory) and Convolvulus arvensis (field bindweed);
Labiatae weeds such as Lamium purpureum (purple deadnettle) and Lamium amplexicaule (henbit);
Solanaceae weeds such as Datura stramonium (jimsonweed) and Solanum nigrum (black nightshade);
Scrophulariaceae weeds such as Veronica persica (Persian speedwell) and Veronica hederaefolia (ivyleaf speedwell);
Compositae weeds such as Xanthium pensylvanicum (common cocklebur), Helianthus annuus (common sunflower), Matricaria inodora (scentless chamomile), Chrysanthemum segetum (corn marigold), Matricaria matricarioides (pineappleweed), Ambrosia artemisiifolia (common ragweed), Ambrosia trifida (giant ragweed), Erigeron Canadensis (horseweed), Artemisia princes (Japanese mugwort) and Solidago altissima (tall goldenrod);
Boraginaceae weeds such as Myosotis arvensis (forget-me-not);
Asclepiadaceae weeds such as Asclepias syriaca (common milkweed);
Euphorbiaceae weeds such as Euphorbia helioscopia (sun spurge) and Euphorbia maculata (spotted spurge);
Gramineae weeds such as Echinochloa crus-galli (barnyardgrass), Setaria viridis (green foxtail), Setaria faberi (giant foxtail), Digitaria sanguinalis (southern crabgrass), Eleusine indica (goosegrass), Poa annua (annual bluegrass), Alopecurus myosuroides (blackgrass), Avena fatus (wild oats), Sorghum halepense (Johnsongrass), Agropyron repens (quackgrass), Bromus tectorum (downy brome), Cynodone dactylon (Bermudagrass), Panicum dichotomiflorum (fall panicum), Panicum texanum (Texas panicum), Sorghum vulgare (shattercane) and Lolium multiflorum (Italian ryegrass);
Commelinaceae weeds such as Commelina communis (Asiatic dayflower) and Commelina benghalensis (Bengal dayflower);
Equisetaceae weeds such as Equisetum arvense (field horsetail); and
Cyperaceae weeds such as Cyperus iria (rice flatsedge), Cyperus rotundus (purple nutsedge) and Cyperus esculentus (yellow nutsedge).

### EXAMPLES

Hereinafter, the present invention is explained by examples in detail; however, the invention is not restricted by the following examples.

Formulation examples of the composition for using the method of the present invention are given below. In the examples, part(s) means part(s) by weight.

### Formulation Example 1

Twenty-five parts of Flumioxazin, 25 parts of Imazosulfuron, 3 parts of calcium ligninsulfonate, 2 parts of sodium laurylsulfate and 45 parts of synthetic hydrated silica are well pulverized and mixed to give wettable powder.

### Formulation Example 2

Seventy parts of Flumioxazin, 14 parts of Imazosulfuron, 3 parts of calcium ligninsulfonate, 2 parts of sodium laurylsulfate and 11 parts of synthetic hydrated silica are well pulverized and mixed to give wettable powder.

### Formulation Example 3

Fourteen parts of Flumioxazin, 70 parts of Imazosulfuron, 3 parts of calcium ligninsulfonate, 2 parts of sodium laurylsulfate and 11 parts of synthetic hydrated silica are well pulverized and mixed to give wettable powder.

### Formulation Example 4

Ten parts of Flumioxazin, 5 parts of Imazosulfuron, 3 parts of calcium ligninsulfonate, 2 parts of sodium laurylsulfate and 80 parts of synthetic hydrated silica are well pulverized and mixed to give wettable powder.

### Formulation Example 5

Twenty parts of Flumioxazin, 20 parts of Imazosulfuron, 3 parts of polyoxyethylene sorbitan monooleate, 3 parts of CMC (carboxymethylcellulose) and 54 parts of water are mixed and wet-pulverized to make the particle diameter to 5μ or less to give suspensible concentrate.

### Formulation Example 6

Fifty parts of Flumioxazin, 10 parts of Imazosulfuron, 3 parts of polyoxyethylene sorbitan monooleate, 3 parts of CMC (carboxymethylcellulose) and 34 parts of water are mixed and wet-pulverized to make the particle diameter to 5μ or less to give suspensible concentrate.

### Formulation Example 7

Five parts of Flumioxazin, 25 parts of Imazosulfuron, 3 parts of polyoxyethylene sorbitan monooleate, 3 parts of CMC (carboxymethylcellulose) and 64 parts of water are mixed and wet-pulverized to make the particle diameter to 5μ or less to give suspensible concentrate.

### Formulation Example 8

Four parts of Flumioxazin, 2 parts of Imazosulfuron, 3 parts of polyoxyethylene sorbitan monooleate, 3 parts of CMC (carboxymethylcellulose) and 88 parts of water are mixed and wet-pulverized to make the particle diameter to 5μ or less to give suspensible concentrate.

Biological tests are given below.

Valuation Basis

The herbicidal activity is evaluated at 6 levels using the indices of 0 to 5, i.e., shown by “0”, “1”, “2”, “3”, “4” or “5”, wherein a score of “0” means that there is no or little difference in the degree of growth between treated plants and untreated plants at the time of observation and a score of “5” means that the test plants die completely or their growth is completely inhibited. The herbicidal values of “4” and “5” show excellent herbicidal activity. The phytotoxicity is evaluated at 4 levels using “no damage”, “small”, “medium” or “severe”, wherein “no damage” means that no damage is found or the damage practically causes no problem, “small” means that the damage is light but practically impermissible, “medium” means that the damage is medium and “severe” means that severe damage is found.

### Test Example 1

### Test for Peanut Field

Plastic pots each having a diameter of 18 cm and depth of 14 cm were filled with upland soil, and then seeded with yellow nutsedge (Cyperus esculentus), hemp sesbania (Seshania exaltata) and sicklepod (Cassia obtusifolia). In a greenhouse, they were grown for 12 days. Flumioxazin water dispersible granules (commercial name: Valor SX, produced by Valent U.S.A.), Imazosulfuron emulsifiable concentrate (produced by mixing well 5 parts of Imazosulfuron, 65 parts of cyclohexanone, 13 parts of Sorpol 2680 (Toho Chemical's product) and 17 parts of dimethylformamide) and a mixture of the Flumioxazin water dispersible granules and the Imazosulfuron emulsifiable concentrate were independently diluted in their designated amounts with water. Each dilution was uniformly sprayed over the test plants with a small sprayer. After the application, the test plants were grown in the greenhouse for 7 days, and the herbicidal activity was then examined. Further, the pots were seeded with peanut (Arachis hypogea) 7 days after the application, and the phytotoxicity against the crop was examined 10 days after the seeding. The results are shown in Table 1.

TABLE 1

| | Amount of | | | | |
|---|---|---|---|---|---|
| | active | Herbicidal | | | Phytotoxicity |
| | ingredient | activity | | | against crop |
| Test compound | (g/ha) | Ce | Se | Co | Peanut |
| Flumioxazin | 30 | 0 | 1 | 0 | No damage |
| Flumioxazin | 60 | 0 | 1 | 1 | No damage |
| Imazosulfuron | 60 | 2 | 2 | 1 | No damage |
| Imazosulfuron | 120 | 2 | 3 | 1 | No damage |
| Flumioxazin + Imazosulfuron | 30 + 60 | 4 | 5 | 4 | No damage |
| Flumioxazin + Imazosulfuron | 30 + 120 | 4 | 5 | 5 | No damage |
| Flumioxazin + Imazosulfuron | 60 + 60 | 4 | 5 | 4 | No damage |
| Flumioxazin + Imazosulfuron | 60 + 120 | 5 | 5 | 4 | No damage |

In the above table, Ce means yellow nutsedge, Se means hemp sesbania and Co means sicklepod.

As shown in Table 1 above, excellent herbicidal effect was provided in the area treated with Flumioxazin and Imazosulfuron compared to the area treated with Flumioxazin or Imazosulfuron solely. Further, there was no damage practically causes problem for the crop. Thus, the weed selected from the group consisting of Cyperus spp., Sesbania spp. and Cassia spp. can be controlled well in peanut field by the application of Flumioxazin and Imazosulfuron.

### Test Example 2

### Test for Vegetable Field

Plastic pots each having a diameter of 18 cm and depth of 14 cm were filled with upland soil, and then seeded with barnyardgrass (Echinochloa crus-gall) and onion (Allium cepa). The next day, a designated amount of Flumioxazin granules (commercial name: BroadStar, produced by Valent U.S.A.), Imazosulfuron granules (commercial name: Takeoff Granule, produced by Sumitomo Chemical Takeda Agro Company), or a mixture of Flumioxazin granules and Imazosulfuron granules was independently applied to a soil surface. After the application, the test plants were grown for 29 days, and the herbicidal activity and phytotoxicity were then examined. The results are shown in Table 2.

TABLE 2

| | Amount of active | Herbicidal activity | Phtotoxicity |
|---|---|---|---|
| Test compound | ingredient (g/ha) | Barnyardgrass | Onion |
| Flumioxazin | 20 | 1 | No damage |
| Imazosulfuron | 50 | 0 | No damage |
| Flumioxazin + | 20 + 50 | 4 | No damage |
| Imazosulfuron | | | |

As shown in Table 2, excellent herbicidal effect was provided in the area treated with the composition of the invention compared to the area treated with Flumioxazin or Imazosulfuron solely. Further, there was no damage practically causes problem for the crop. Thus, the weed of Echinochloa sp. can be controlled well in onion field by the application of Flumioxazin and Imazosulfuron.

### Test Example 3

### Test for Vegetable Field

Plastic pots (32 cm×22 cm, depth: 8 cm) were filled with upland soil, seedlings of eggplant (Solanum melongena) and tomato (Lycopersicum esculentum) were transplanted and then seeded with black nightshade (Solanum nigrum), jimsonweed (Datura stramonium), giant foxtail (Setaria faberi), southern crabgrass (Digitaria sanguinalis), common chickweed (Stellaria media), common lambsquarters (Chenopodium album) and redroot pigweed (Amaranthus retroflexus). The next day, a designated amount of a mixture of Flumioxazin water dispersible granules (commercial name: ValorSX, produced by Valent U.S.A.) and Imazosulfuron Suspensible concentrates (commercial name: Sibatito 40, produced by Sumitomo Chemical Takeda Agro Company) was diluted with water and applied uniformly to a soil surface with a small sprayer. After the application, the test plants were grown in the greenhouse for 17 days, and the herbicidal activity and phytotoxicity were then examined. The results are shown in Table 3.

TABLE 3

| | Amount of active | Herbicidal activity | | | | | | | Phtotoxicity | |
|---|---|---|---|---|---|---|---|---|---|---|
| Test compound | ingredient (g/ha) | Sn | Ds | Sf | Dg | St | Ca | Ar | eggplant | tomato |
| Flumioxazin + Imazosulfuron | 20 + 50 | 5 | 5 | 5 | 5 | 5 | 5 | 5 | No damage | No damage |
| Flumioxazin + Imazosulfuron | 20 + 250 | 5 | 5 | 5 | 5 | 5 | 5 | 5 | No damage | No damage |

In the above table, Sn means black nightshade, Ds means jimsonweed, Sf means giant foxtail, Dg means southern crabgrass, St means common chickweed, Ca means common lambsquarters and Ar means redroot pigweed.

As shown in the above results, the weed selected from the group consisting of Solanum spp., Datura spp., Setaria spp., Digitaria spp., Stellaria spp., Chenopodium spp. and Amaranthus spp. can be controlled well in eggplant or tomato field by the application of Flumioxazin and Imazosulfuron.

### Test Example 4

### Test for Vegetable Field

Plastic pots (26 cm×19 cm, depth: 7 cm) were filled with upland soil, seedlings of cabbage (Brassica Oleracea) were transplanted and then seeded with shepherdspurse (Capsella bursa-pastoris), wild mustard (Sinapis arvensis), giant foxtail (Setaria faberi), southern crabgrass (Digitaria sanguinalis), common chickweed (Stellaria media), common lambsquarters (Chenopodium album) and redroot pigweed (Amaranthus retroflexus). The next day, a designated amount of a mixture of Flumioxazin water dispersible granules (commercial name: ValorSX, produced by Valent U.S.A.) and Imazosulfuron Suspensible concentrates (commercial name: Sibatito 40, produced by Sumitomo Chemical Takeda Agro Company) was diluted with water and applied uniformly to a soil surface with a small sprayer. After the application, the test plants were grown in the greenhouse for 17 days, and the herbicidal activity and phytotoxicity were then examined. The results are shown in Table 4.

TABLE 4

| | Amount of active | Herbicidal activity | | | | | | | Phtotoxicity |
|---|---|---|---|---|---|---|---|---|---|
| Test compound | ingredient (g/ha) | Cb | Sa | Sf | Dg | St | Ca | Ar | cabbage |
| Flumioxazin + Imazosulfuron | 20 + 50 | 5 | 5 | 5 | 5 | 5 | 5 | 5 | No damage |
| Flumioxazin + Imazosulfuron | 20 + 250 | 5 | 5 | 5 | 5 | 5 | 5 | 5 | No damage |
| Flumioxazin + Imazosulfuron | 100 + 50 | 5 | 5 | 5 | 5 | 5 | 5 | 5 | No damage |
| Flumioxazin + Imazosulfuron | 100 + 250 | 5 | 5 | 5 | 5 | 5 | 5 | 5 | No damage |

In the above table, Cb means shepherdspurse, Sa means wild mustard, Sf means giant foxtail, Dg means southern crabgrass, St means common chickweed, Ca means common lambsquarters and Ar means redroot pigweed.

As shown in the above results, the weed selected from the group consisting of Capsella spp., Sinapis spp., Setaria spp., Digitaria spp., Stellaria spp., Chenopodium spp. and Amaranthus spp. can be controlled well in cabbage field by the application of Flumioxazin and Imazosulfuron.

### Test Example 5

### Test for Vegetable Field

Plastic pots each having a diameter of 18 cm and depth of 14 cm were filled with upland soil, seedlings of strawberry (Fragaria ananassa) was transplanted and then seeded with giant foxtail (Setaria faberi). The next day, a designated amount of Flumioxazin granules (commercial name: BroadStar, produced by Valent U.S.A.), Imazosulfuron granules (commercial name: Takeoff Granule, produced by Sumitomo Chemical Takeda Agro Company), or a mixture of Flumioxazin granules and Imazosulfuron granules was independently applied to a soil surface. After the application, the test plants were grown for 17 days in the greenhouse, and the herbicidal activity and phytotoxicity were then examined. The results are shown in Table 5.

TABLE 5

| | Amount of active | Herbicidal activity | Phtotoxicity |
|---|---|---|---|
| Test compound | ingredient (g/ha) | giant foxtail | strawberry |
| Flumioxazin | 40 | 2 | No damage |
| Imazosulfuron | 50 | 0 | No damage |
| Imazosulfuron | 250 | 1 | No damage |
| Flumioxazin + | 40 + 50 | 5 | No damage |
| Imazosulfuron | | | |
| Flumioxazin + | 40 + 250 | 5 | No damage |
| Imazosulfuron | | | |

As shown in the above results, the weed of Setaria sp. can be controlled well in strawberry field by the application of Flumioxazin and Imazosulfuron.

### Test Example 6

### Test for Vegetable Field

Plastic pots (26 cm×19 cm, depth: 7 cm) were filled with upland soil, seedlings of cucumber (Cucumis sativus), squash (Cucurbita moschata) and mint (Mentha spp.) were transplanted and then seeded with barnyardgrass (Echinochloa crus-galli), southern crabgrass (Digitaria sanguinalis), common chickweed (Stellaria media), redroot pigweed (Amaranthus retroflexus) and Persian speedwell (Veronica persica). The next day, a designated amount of a mixture of Flumioxazin granules (commercial name: BroadStar, produced by Valent U.S.A.) and Imazosulfuron granules (commercial name: Takeoff Granule, produced by Sumitomo Chemical Takeda Agro Company) was applied uniformly to a soil surface. After the application, the test plants were grown in the greenhouse for 14 days in the greenhouse, and the herbicidal activity and phytotoxicity were then examined. The results are shown in Table 6.

TABLE 6

| | Amount of active | Herbicidal activity | | | | | Phtotoxicity | | |
|---|---|---|---|---|---|---|---|---|---|
| Test compound | ingredient (g/ha) | Ec | Dg | St | Ar | Vp | Cs | Cm | Ms |
| Flumioxazin + Imazosulfuron | 40 + 50 | 5 | 5 | 5 | 5 | 5 | No damage | No damage | No damage |
| Flumioxazin + Imazosulfuron | 40 + 250 | 5 | 5 | 5 | 5 | 5 | No damage | No damage | No damage |

In the above table, Ec means barnyardgrass, Dg means southern crabgrass, St means common chickweed, Ar means redroot pigweed and Vp means Persian speedwell. Further, Cs means cucumber, Cm means squash and Ms means mint.

As shown in the above results, the weed selected from the group consisting of Echinochloa spp., Digitaria spp., Stellaria spp., Amaranthus spp. and Veronica spp. can be controlled well in cucumber, pumpkin or mint field by the application of Flumioxazin and Imazosulfuron.

### Test Example 7

### Test for Tree Field

In the fruit tree land where Japanese pear and Satsuma orange grow, a designated amount of a mixture of Flumioxazin water dispersible granules (commercial name: ValorSX, produced by Valent U.S.A.) and Imazosulfuron Suspensible concentrates (commercial name: Sibatito 40, produced by Sumitomo Chemical Takeda Agro Company) was diluted with water and applied uniformly on ivyleaf morningglory (Ipomoea hederacea) and field horsetail (Equisetum arvense) with a carbon dioxide sprayer. The herbicidal activity and phytotoxicity were examined 63 days after the application. The results are shown in Table 7.

TABLE 7

| | Amount of | | | | |
|---|---|---|---|---|---|
| | active | Herbicidal | | | |
| Test | ingredient | activity | | Phtotoxicity | |
| compound | (g/ha) | Ih | Ea | pear | orange |
| Flumioxazin + | 50 + 100 | 4 | 4 | No | No |
| Imazosulfuron | | | | damage | damage |
| Flumioxazin + | 50 + 1000 | 5 | 5 | No | No |
| Imazosulfuron | | | | damage | damage |
| Flumioxazin + | 500 + 100 | 5 | 4 | No | No |
| Imazosulfuron | | | | damage | damage |
| Flumioxazin + | 500 + 1000 | 5 | 5 | No | No |
| Imazosulfuron | | | | damage | damage |

In the above table, Ih means ivyleaf morningglory and Ea means field horsetail.

### Test Example 8

### Test for Tree Field

In the greenhouse, plastic containers (46 cm×31 cm, depth: 26 cm) were filled with upland soil, peach trees were transplanted and grown, and then seeded with redroot pigweed (Amaranthus retroflexus), common chickweed (Stellaria media), southern crabgrass (Digitaria sanguinalis) and annual bluegrass (Poa annua). Then, a designated amount of a mixture of Flumioxazin granules (commercial name: BroadStar, produced by Valent U.S.A.) and Imazosulfuron granules (commercial name: Takeoff Granule, produced by Sumitomo Chemical Takeda Agro Company) was applied uniformly to a soil surface. The herbicidal activity and phytotoxicity were examined 23 days after the application. The results are shown in Table 8.

TABLE 8

| | Amount of active | Herbicidal activity | | | | Phtotoxicity |
|---|---|---|---|---|---|---|
| Test compound | ingredient (g/ha) | Ar | St | Dg | Pa | peach |
| Flumioxazin + | 120 + 90 | 5 | 5 | 5 | 5 | No damage |
| Imazosulfuron | | | | | | |

In the above table, Ar means redroot pigweed, St means common chickweed, Dg means southern crabgrass and Pa means bluegrass.

### Test Example 9

### Test for Tree Field

In the greenhouse, plastic containers (46 cm×31 cm, depth: 26 cm) were filled with upland soil, grape trees were transplanted and grown, and then seeded with redroot pigweed (Amaranthus retroflexus), common chickweed (Stellaria media), southern crabgrass (Digitaria sanguinalis) and annual bluegrass (Poa annua). Then, a designated amount of a mixture of Flumioxazin granules (commercial name: BroadStar, produced by Valent U.S.A.) and Imazosulfuron granules (commercial name: Takeoff Granule, produced by Sumitomo Chemical Takeda Agro Company) was applied uniformly to a soil surface. The herbicidal activity and phytotoxicity were examined 23 days after the application. The results are shown in Table 9.

TABLE 9

| | Amount of active | Herbicidal activity | | | | Phtotoxicity |
|---|---|---|---|---|---|---|
| Test compound | ingredient (g/ha) | Ar | St | Dg | Pa | grape |
| Flumioxazin + | 80 + 160 | 5 | 5 | 5 | 5 | No damage |
| Imazosulfuron | | | | | | |

In the above table, Ar means redroot pigweed, St means common chickweed, Dg means southern crabgrass and Pa means bluegrass.

### Test Example 10

### Test for Tree Field

In the greenhouse, plastic containers (46 cm×31 cm, depth: 26 cm) were filled with upland soil, chestnut trees were transplanted and grown, and then seeded with redroot pigweed (Amaranthus retroflexus), common chickweed (Stellaria media), southern crabgrass (Digitaria sanguinalis) and annual bluegrass (Poa annua). Then, a designated amount of a mixture of Flumioxazin granules (commercial name: BroadStar, produced by Valent U.S.A.) and Imazosulfuron granules (commercial name: Takeoff Granule, produced by Sumitomo Chemical Takeda Agro Company) was applied uniformly to a soil surface. The herbicidal activity and phytotoxicity were examined 23 days after the application. The results are shown in Table 10.

TABLE 10

| | Amount of active | Herbicidal activity | | | | Phtotoxicity |
|---|---|---|---|---|---|---|
| Test compound | ingredient (g/ha) | Ar | St | Dg | Pa | chestnut |
| Flumioxazin + | 50 + 200 | 5 | 5 | 5 | 5 | No damage |
| Imazosulfuron | | | | | | |

In the above table, Ar means redroot pigweed, St means common chickweed, Dg means southern crabgrass and Pa means bluegrass.

As shown in Tables 7, 8, 9 and 10, the weed selected from the group consisting of Ipomoea spp., Equisetum spp., Amaranthus spp., Stellaria spp., Digitaria spp. and Poa spp. can be controlled well in tree field (e.g., pear, orange, peach, grape, chestnut) by the application of Flumioxazin and Imazosulfuron.

### Test Example 11

### Test for Non-Cultivated Land

A designated amount of a mixture of Flumioxazin water dispersible granules (commercial name: ValorSX, produced by Valent U.S.A.) and Imazosulfuron Suspensible concentrates (commercial name: Sibatito 40, produced by Sumitomo Chemical Takeda Agro Company) was diluted with water and applied uniformly onto a ground surface and growing weeds (including common vetch (Vicia sativa), cleavers (Galium aparine), Persian speedwell (Veronica persica), henbit (Lamium amplexicaule) and Carolina geranium (Geranium carolinianum)) on the graveled (about 10 cm) land with a carbon dioxide sprayer. The herbicidal activity was examined 20 days after the application. The results are shown in Table 11. Further, the fresh weight of the growing weeds on the ground of the designated area was measured 36 days after the application. For the comparison, the fresh weight of the growing weeds without the application was measured. Furthermore, the fresh weight of the growing weeds, where the weeds had been pulled out by hand instead of the application, was also measured.

TABLE 11

| | Amount of active | Herbicidal activity | | | | |
|---|---|---|---|---|---|---|
| Test compound | ingredient (g/ha) | Vs | Ga | Vp | La | Gc |
| Flumioxazin + Imazosulfuron | 200 + 400 | 5 | 5 | 5 | 5 | 5 |

In the above table, Vs means common vetch, Ga means cleavers, Vp means Persian speedwell, La means henbit and Gc means Carolina geranium.

TABLE 12

| | Amount of active | Fresh weight of |
|---|---|---|
| Tested area | ingredient (g/ha) | weeds (g/m²) |
| Flumioxazin + | 200 + 400 | 2.2 |
| Imazosulfuron | | |
| No treatment | 0 | 249 |
| Hand weeding | 0 | 182 |

As shown in Table 12, the method for controlling weeds of the present invention is effective against the weeds which grow from the gap of the graveled.

### Test Example 12

### Test for Non-Cultivated Land

Plastic pots each having a diameter of 9 cm and depth of 7 cm were filled with upland soil, and then seeded with kudzu (Pueraria lobata). The next day, a designated amount of a mixture of Flumioxazin water dispersible granules (commercial name: Valor SX, produced by Valent U.S.A.) and Imazosulfuron Suspensible concentrates (commercial name: Sibatito 40, produced by Sumitomo Chemical Takeda Agro Company) was diluted with water and applied uniformly to a soil surface with a small sprayer. After the application, the test plants were grown in the greenhouse for 14 days, and the herbicidal activity was then examined. The results are shown in Table 13.

TABLE 13

| | Amount of active | Herbicidal activity |
|---|---|---|
| Test compound | ingredient (g/ha) | kudzu |
| Flumioxazin | 100 | 1 |
| Imazosulfuron | 100 | 1 |
| Imazosulfuron | 500 | 2 |
| Flumioxazin + Imazosulfuron | 100 + 100 | 5 |
| Flumioxazin + Imazosulfuron | 100 + 500 | 5 |

As shown in Table 13, excellent herbicidal effect was provided in the area treated with Flumioxazin and Imazosulfuron compared to the area treated with Flumioxazin or Imazosulfuron solely. Thus, the weed of kudzu can be controlled well in non-cultivated land by the application of Flumioxazin and Imazosulfuron.

1. A method for controlling weeds in peanut field, vegetable field, tree field or non-cultivated land which comprises applying N-(7-fluoro-3,4-dihydro-3-oxo-4-prop-2-ynyl-2H-1,4-benzoxadin-6-yl)cyclohex- -ene-1,2-dicarboxamide [Flumioxazin] and 1-(2-chloroimidazo [1,2-a]pyridin-3-ylsulfonyl)-3-(4,6-dimethoxypyrimidin-2-yl)urea [Imazosulfuron], wherein the weight ratio of Flumioxazin:Imazosulfuron is 1:0.1-20, separately or in combination to weeds or to soil in a place where the weeds grow or will grow.

2. The method for controlling weeds in peanut field described in claim 1.

3. The method for controlling weeds in peanut field described in claim 2, wherein the weed is selected from the group consisting of Cyperus spp., Seshania spp. and Cassia spp.

4. The method for controlling weeds in vegetable field described in claim 1.

5. The method for controlling weeds according to claim 4, wherein the vegetable is onion.

6. The method for controlling weeds in onion field described in claim 5, wherein the weed is Echinochloa sp.

7. The method for controlling weeds according to claim 4, wherein the vegetable is eggplant.

8. The method for controlling weeds in eggplant field described in claim 7, wherein the weed is selected from the group consisting of Solanum spp., Datura spp., Setaria spp., Digitaria spp., Stellaria spp., Chenopodium spp. and Amaranthus spp.

9. The method for controlling weeds according to claim 4, wherein the vegetable is tomato.

10. The method for controlling weeds in tomato field described in claim 9, wherein the weed is selected from the group consisting of Solanum spp., Datura spp., Setaria spp., Digitaria spp., Stellaria spp., Chenopodium spp. and Amaranthus spp.

11. The method for controlling weeds according to claim 4, wherein the vegetable is cabbage.

12. The method for controlling weeds in cabbage field described in claim 11, wherein the weed is selected from the group consisting of Capsella spp., Sinapis spp., Setaria spp., Digitaria spp., Stellaria spp., Chenopodium spp. and Amaranthus spp.

13. The method for controlling weeds according to claim 4, wherein the vegetable is strawberry.

14. The method for controlling weeds in strawberry field described in claim 13, wherein the weed is Setaria sp.

15. The method for controlling weeds according to claim 4, wherein the vegetable is cucumber.

16. The method for controlling weeds in cucumber field described in claim 15, wherein the weed is selected from the group consisting of Echinochloa spp., Digitaria spp., Stellaria spp., Amaranthus spp. and Veronica spp.

17. The method for controlling weeds according to claim 4, wherein the vegetable is squash.

18. The method for controlling weeds in squash field described in claim 17, wherein the weed is selected from the group consisting of Echinochloa spp., Digitaria spp., Stellaria spp., Amaranthus spp. and Veronica spp.

19. The method for controlling weeds according to claim 4, wherein the vegetable is mint.

20. The method for controlling weeds in mint field described in claim 19, wherein the weed is selected from the group consisting of Echinochloa spp., Digitaria spp., Stellaria spp., Amaranthus spp. and Veronica spp.

21. The method for controlling weeds in tree field described in claim 1.

22. The method for controlling weeds in tree field described in claim 21, wherein the weed is selected from the group consisting of Ipomoea spp., Equisetum spp., Amaranthus spp., Stellaria spp., Digitaria spp. and Poa spp.

23. The method for controlling weeds according to claim 21 or 22, wherein the tree field is a pear tree field.

24. The method for controlling weeds according to claim 21 or 22, wherein the tree field is an orange tree field.

25. The method for controlling weeds according to claim 21 or 22, wherein the tree field is a peach tree field.

26. The method for controlling weeds according to claim 21 or 22, wherein the tree field is a grape tree field.

27. The method for controlling weeds according to claim 21 or 22, wherein the tree field is a nut tree field.

28. The method for controlling weeds in non-cultivated land described in claim 1.

29. Use of a combination of N-(7-fluoro-3,4-dihydro-3-oxo-4-prop-2-ynyl-2H-1,4-benzoxadin-6-yl)cyclohex-1-ene-1,2-dicarboxamide [Flumioxazin] and 1-(2-chloroimidazo[1,2-a]pyridin-3-ylsulfonyl)-3-(4,6-dimethoxypyrimidin-2-yl)urea [Imazosulfuron], wherein the weight ratio of Flumioxazin:Imazosulfuron is 1:0.1-20, as active ingredients for controlling weeds in peanut field, vegetable field, tree field or non-cultivated land.
